(19) United States
(12) Patent Application Publication
(10) Pub. No.: US 2004/0103172 A1
(43) Pub. Date: May 27, 2004

(54) Method of updating an operation system

(75) Inventors: Hung-Ming Chen, Taipei (TW); Chiao-Wei Wang, Ilan (TW); Lu-Yun Tai, Taoyuan (TW)

Correspondence Address: BACON & THOMAS, PLLC, 625 SLATERS LANE, FOURTH FLOOR, ALEXANDRIA, VA, 22314

(73) Assignee: Tatung Co., Ltd., Taipei (TW)

(21) Appl. No.: 10/357,224

(22) Filed: Feb. 4, 2003

(30) Foreign Application Priority Data
Nov. 12, 2002 (TW) 91133196

(51) Int. Cl. G06F 15/177; G06F 9/44; G06F 9/00; G06F 1/24

(52) U.S. Cl. 709/221; 713/100; 717/171

(57) ABSTRACT

The present invention relates to a method of updating an operating system image of a portable information device, wherein the portable information device comprises a burn program for burning a new operating system image to a memory of the portable information device. The method first detects size of the new operating system image saved in an external device; then checks if an available capacity of the memory is sufficient for the new operating system image; if the available capacity is sufficient, proceeding to a subsequent step; further, it downloads the new operating system image from the external device; and finally starts the burn program to burn the external new operating system image to the memory.

### BACKGROUND OF THE INVENTION

1. Field of the Invention

The present invention relates to a method of updating an operation system and, more particularly, to a method of updating an operation system for a portable information device.

2. Description of Related Art

A prior art operation system applied in a portable information device is manufactured by directly burning an operation system image in a memory during a manufacturing process. For example, a Windows CE operation system is burned in a 32MB flash memory.

However, since the prior art operation system of the portable information device is done, its content will not be modified. Therefore, if the operation system has bugs or needs to be updated, a user must remove a housing of the portable information device to take out the memory and re-burn memory to update the operation system. It is very inconvenient for the user, because the user has to repeat the above-mentioned steps, which may damage the internal parts in the portable information device and waste a lot of time.

Therefore, it is desirable to provide an improved method of updating an operation system to mitigate and/or obviate the aforementioned problems.

### SUMMARY OF THE INVENTION

The object of the present invention is to provide a method of updating an operation system, which makes the updating process easier.

Another object of the present invention is to provide which can reduce developing cost and maintaining cost of the manufacturer.

In order to achieve the above-mentioned object, the method of updating an operation system applied in a portable information device wherein the portable information device comprises a burn program for burning a new operation system image to a memory of the portable information device. The method comprising following steps:

(A) detecting size of the new operation system image saved in an external device;

(B) checking if a valuable capacity of the memory is enough for the new operation system image; if it is enough, continuous a subsequent step;

(C) downloading the new operation system image from the external device; and

(D) starting the burn program to burn the external new operation system image to the memory to be updated.

The execution steps can be performed by a software program, so the method of the invention can be written as a computer langue into a computer readable record medium. The computer readable record medium can be an IC chip, hard disk, optical disk or other product, but a RAM memory is preferred.

Other objects, advantages, and novel features of the invention will become more apparent from the following detailed description when taken in conjunction with the accompanying drawings.

### BRIEF DESCRIPTION OF THE DRAWINGS

FIG. 1 illustrates an environment schematic drawing of the present invention.

FIG. 2 is a function block drawing of an embodiment of the present invention.

FIG. 3 is a flow chart of a first embodiment of the invention.

FIG. 4 is a flow chart of a second embodiment of the invention.

FIG. 5 is a flow chart of a third embodiment of the invention.

### DETAILED DESCRIPTION OF THE PREFERRED EMBODIMENT

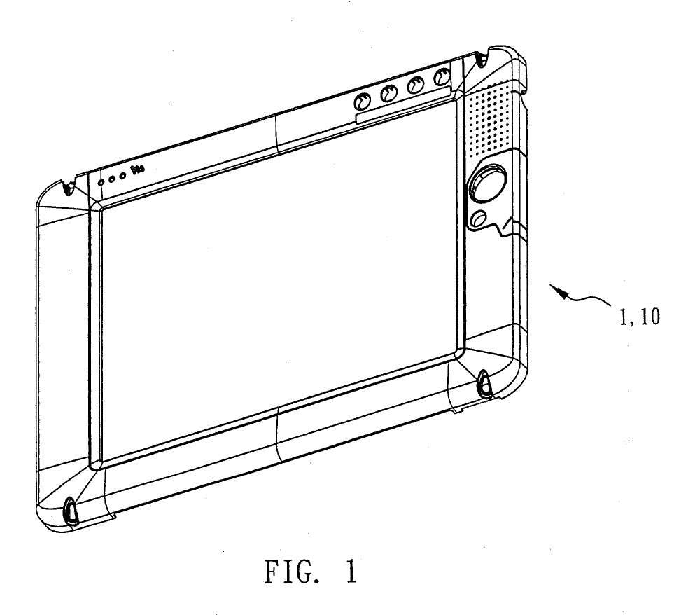

Please refer to FIG. 1. FIG. 1 illustrates an environment schematic drawing of the present invention. A portable information device 1 of this embodiment is a WebPAD 10; however, the portable information device 1 may also be a tablet PC, PDA, pocket PC or other similar information device. The WebPAD 10 utilizes a Windows CE.NET operating system burned into a non-volatile memory 15.

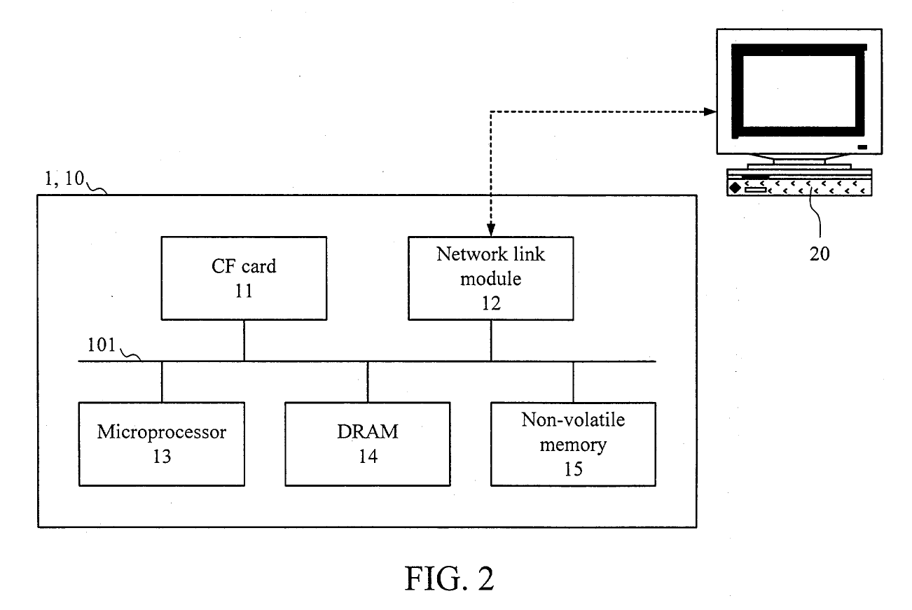

Please refer to FIG. 2. FIG. 2 is a function block drawing of an embodiment of the present invention. The WebPAD 10 contains a CF card 11, a network link module 12, a microprocessor 13, a dynamic random access memory (DRAM) 14 and the non-volatile memory 15, all of which are connected to a bus 101. Furthermore, the CF card 11 is inserted in a slot (not shown) of the WebPAD 10. The network link module 12 may be a wired connection, such as Ethernet, or a wireless connection, such as a WIFI network. The dynamic random access memory (DRAM) 14 may be a synchronic dynamic random access memory (SDRAM) or a double data rate (DDR) RAM. The non-volatile memory 15 is a flash memory. In order to update the operating system in the WebPAD 10 by way of an external device, the present invention provides three embodiments, any of which a user may select. In a first embodiment, the CF card 11, which is inserted in the WebPAD 10, performs the updating process; in a second embodiment, the portable information device 1 utilizes a UPNP communications protocol to automatically search a remote computer 20; in a third embodiment, the portable information device 1 utilizes the Windows Network protocol to connect to the remote computer 20. These embodiments are detailed in the following.

The First Embodiment:

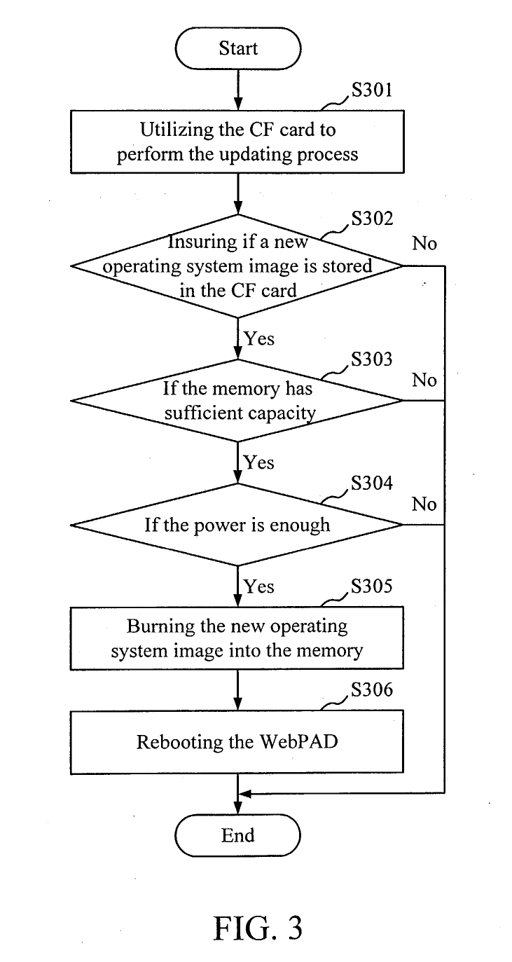

Please refer to FIG. 3. In this embodiment, the user utilizes the CF card 11 to perform the updating process (step S301). The microprocessor 13 first checks to determine if the CF card 11 is inserted in the slot of the WebPAD 10, and then insures that a new operating system image is stored in the CF card 11 (step S302). The microprocessor 13 then detects if the non-volatile memory 15 has sufficient capacity to support the new operating system image (step S303); if the available memory is sufficient, the non-volatile memory 15 is considered capable of undergoing the updating process. Next, the microprocessor 13 determines if the WebPAD 10 has enough power to perform the updating process without interruption (step S304). The microprocessor 13 initiates a burn program to burn the external new operating system image into the non-volatile memory 15 (step S305), and reboots the WebPAD 10 to load the new operating system image into the WebPAD 10 (step S306) to complete the updating process.

The Second Embodiment:

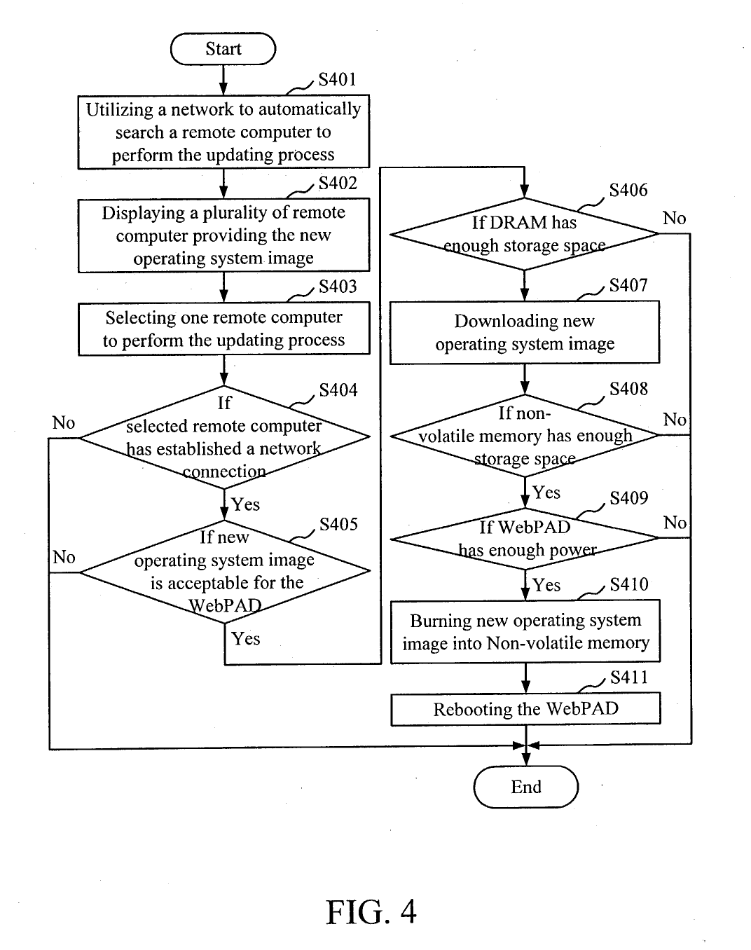

Please refer to FIG. 4. FIG. 4 is a flow chart of a second embodiment of the present invention. In the second embodiment, the user utilizes a network to automatically search a remote computer 20 that will provide the new operating system image (step S401). The WebPAD 10 utilizes a UPNP (universal plug and play) control point function of a UPNP communications protocol to automatically search the remote computer 20 to provide the new operating system image. Since there may be more than one remote computer 20 providing the new operating system image in one domain, when a plurality of remote computers 20 are found (step S402), the user may select one remote computer 20 to perform the updating process (step S403). When the WebPAD 10 and the selected remote computer 20 establish a network connection (step S404), the remote computer 20 initiates a callback program to transmit the new operating system image to the WebPAD 10 to determine if this new operating system image is an acceptable operating system image for the WebPAD 10 (step S405).

The microprocessor 13 determines if the dynamic random access memory (DRAM) 14 has enough storage space to download the new operating system image (step S406); if the DRAM 14 memory is sufficient, the new operating system image is downloaded (step S407); the microprocessor 13 then determines if the non-volatile memory 15 has enough storage space to perform the updating process (step S408); finally, the microprocessor 13 ensures that the WebPAD 10 has enough power to perform the updating process (step S409). The microprocessor 13 starts the burn program to burn the new operating system image, which is temporarily stored in the dynamic random access memory (DRAM) 14, into the non-volatile memory 15 (step S410), and then reboots the WebPAD 10 to load the updated operating system into the WebPAD 10 (step S411) to finish the updating process.

The Third Embodiment:

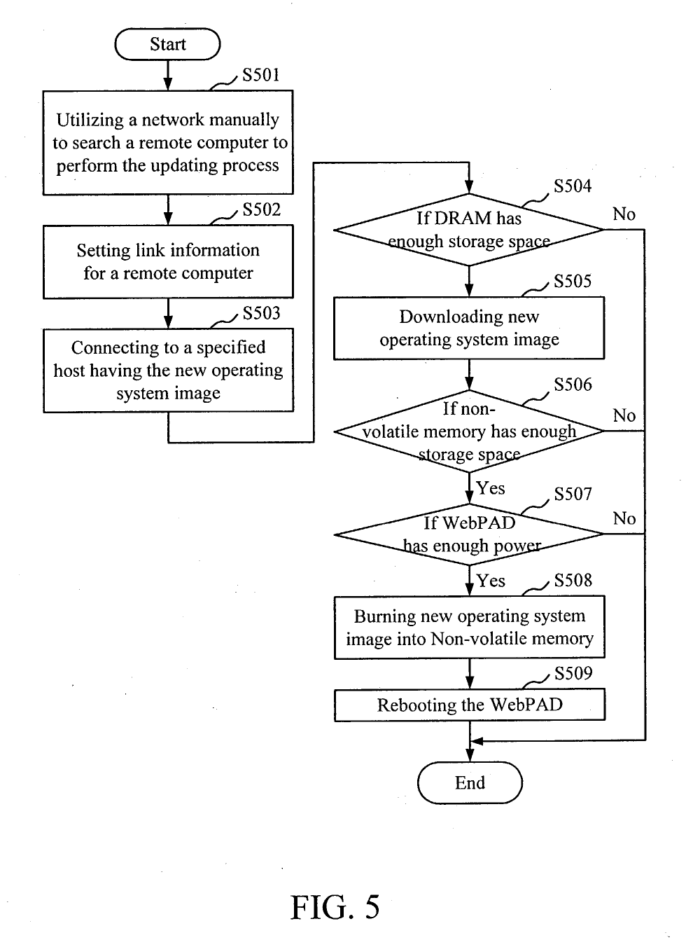

Please refer to FIG. 5. FIG. 5 is a flow chart of a third embodiment of the present invention. The third embodiment is similar to the second embodiment, except that the user selects the remote computer 20 that will provide the new operating system image, and this must be manually set up via the network (step S501). The user sets a UNC (universal naming convention) name, a user account, a user password and a domain name to provide link information (step S502), and connects to a specified host having the new operating system image by way of the Windows Network protocol (step S503). The subsequent steps S504 to S509 are identical to the previously described steps S406 to S411, and so no more description is required.

It is preferred that the above-mentioned embodiments be performed without any power management settings, so as to insure that the updating process will not confuse the user by causing the portable information device 1 to enter into a suspend mode, or screen blanking mode. Furthermore, the portable information device 1 prohibits the user from starting other programs, such as by providing the updating program within a system modal dialog box, to insure that the updating procedure is totally completed.

The method of updating an operating system of the present invention can enable the portable information device 1 to update its operating system from different sources to satisfy different user requirements. Therefore, the user can easily upgrade the operating system to provide a most up-to-date system, without excessive overhead for the manufacturer. Furthermore, the present invention does not require disassembly of the portable information device 1 to perform the updating procedure.

The above-mentioned steps can be written as a software program in any suitable computer language, and be compiled or assembled for execution. The software program can be stored on any recording media that can be recognized and decoded by a processing unit, or any product comprising such a recording media. The recording media can be a hard disk, a floppy disk, an optical disk, a ZIP disk, an MO, an IC chip, RAM, or any other known product. As all of the detailed steps are completely described, there is no need for further explanation.

The invention has been described using exemplary preferred embodiments. However, for those skilled in this field the preferred embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

Although the present invention has been explained in relation to its preferred embodiment, it is to be understood that many other possible modifications and variations can be made without departing from the spirit and scope of the invention as hereinafter claimed.

What is claimed is:

1. A method of updating an operating system image of a portable information device, wherein the portable information device comprises a burn program for burning a new operating system image to a memory of the portable information device, the method comprising:
(A) detecting size of the new operating system image saved in an external device;
(B) checking if an available capacity of the memory is sufficient for the new operating system image; if the available capacity is sufficient, proceeding to a subsequent step;
(C) downloading the new operating system image from the external device; and
(D) starting the burn program to burn the external new operating system image to the memory.

2. The method as claimed in claim 1, wherein the step (D) further comprises a step (E): rebooting the portable information device.

3. The method as claimed in claim 1, wherein the memory is a flash memory.

4. The method as claimed in claim 1, wherein the step (B) further comprises: determining if sufficient power is available to the portable information device; if it the available power is sufficient, continuing to step (C).

5. The method as claimed in claim 1, wherein the external device is an external storage card inserted in the portable information device.

6. The method as claimed in claim 5, wherein the external storage card is a CF card.

7. The method as claimed in claim 1, wherein the external device is a remote computer, and the portable information device is connected to the remote computer via a network link.

8. The method as claimed in claim 7, wherein the portable information device utilizes a universal plug and play (UPNP) communications protocol to automatically search the remote computer to provide the new operating system image, and a user computer can be connected to the remote computer to perform the update procedure.

9. The method as claimed in claim 7, wherein the portable information device has link information, and the portable information device is connected to the remote computer via a Windows Network protocol according to the link information; the link information comprising a universal naming convention (UNC) of the remote computer, a user account, a user password and a domain name.

10. The method as claimed in claim 7, wherein the portable information device is a WebPAD.

11. The method as claimed in claim 7 wherein the method is performed without power management settings.

12. The method as claimed in claim 7 wherein the method is executed within a system modal dialog box.

13. A computer readable record medium loaded with a software program applicable in a portable information device, wherein the portable information device comprises a burn program for burning a new operating system image to a memory of the portable information device, the software program comprising:
A first program code, for detecting a size of the new operating system image saved in an external device;
A second program code, for determining if an available capacity of the memory is sufficient for the new operating system image; if the available memory is sufficient, continuing to a subsequent program code;
A third program code, for downloading the new operating system image from the external device; and
A fourth program code, for starting the burn program to burn the external new operating system image to the memory.

14. The computer readable record medium as claimed in claim 13 wherein the fourth program code further comprises a fifth program code: rebooting the portable information device.

15. The computer readable record medium as claimed in claim 13 wherein the wherein the second program further comprises: determining if sufficient power is supplied to the portable information device; if the supplied power is sufficient, continuing to the third program code.
